(19) United States
(12) Patent Application Publication
(10) Pub. No.: US 2003/0084916 A1
(43) Pub. Date: May 8, 2003

(54) Ultrasonic cleaning products comprising cleaning composition having dissolved gas

(76) Inventors: Sonia Gaaloul, Strombeek-Bever (BE); Tim Van Hauwermeiren, Montisilvano (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/272,966

(22) Filed: Oct. 17, 2002

Related U.S. Application Data
(60) Provisional application No. 60/330,373, filed on Oct. 18, 2001.

(51) Int. Cl. B08B 3/12

(52) U.S. Cl. 134/1; 134/30; 134/34; 134/184; 134/201; 8/137; 510/276; 510/302; 510/435; 366/127

(57) ABSTRACT

Ultrasonic cleaning products comprise a cleaning composition comprising a cleaning component and a source of dissolved gas and an ultrasonic wave generating source for imparting ultrasonic energy to a surface to be cleaned. Methods for removing soil from a surface in need of cleaning comprise applying a cleaning composition comprising a cleaning component and a source of a dissolved gas to a surface in need of cleaning, and contacting the surface with a source of ultrasonic energy.

### RELATED APPLICATIONS

This application claims priority to U.S. Provisional Application Serial No. 60/330,373 filed Oct. 18, 2001.

### FIELD OF THE INVENTION

The present invention is directed to ultrasonic cleaning products and methods for removing soils using ultrasonic waves. More particularly, the present invention is directed to ultrasonic cleaning products and methods which employ a cleaning composition having a source of dissolved gas therein and an ultrasonic wave generating source for imparting ultrasonic energy to a surface to be cleaned.

### BACKGROUND OF THE INVENTION

Ultrasonic cleaning is a well-known cleaning process in industry. For example, ultrasonic cleaning is used to clean electronic components after or during immersion in cleaning solution such as azeotropic mixtures of fluorohydrocarbons. Ultrasonic cleaning has also been used domestically to a small extent in oral hygiene, as in ultrasonic toothbrushes.

Ultrasonic cleaning devices for domestic use in removing stains and soils from domestic surfaces, including hard surfaces and fibrous surfaces, are disclosed in U.S. Provisional Application Serial No. 60/165,758 filed Nov. 16, 1999 and International Application PCT/US00/31431 filed Nov. 15, 2000 and in U.S. application Ser. No. 09/831,783 filed Nov. 16, 1999, all of which are incorporated herein by reference. Cleaning ingredients and compositions which provide surprising and unexpected superior cleaning when used in conjunction with ultrasonic energy are also disclosed. These ultrasonic cleaning devices provide consumers with improved means for removing soils and stains from various household items including, but not limited to, fibrous surfaces such as garments, upholsteries and other fabrics, and carpets and hard surfaces.

### SUMMARY OF THE INVENTION

Accordingly, the present invention is directed to enhanced ultrasonic cleaning products and methods providing improved cleaning effects.

In one embodiment, the invention is directed to an ultrasonic cleaning product comprising a cleaning composition and an ultrasonic wave generating source for imparting ultrasonic energy to a surface to be cleaned. The cleaning composition comprises a cleaning component and a source of dissolved gas.

In another embodiment, the invention is directed to methods for removing soil from a surface in need of cleaning. The methods comprise applying a cleaning composition comprising a cleaning component and a source of a dissolved gas to a surface in need of cleaning, and contacting the surface with a source of ultrasonic energy.

In a further embodiment, the invention is directed to an ultrasonic cleaning composition comprising a cleaning component and a source of dissolved gas.

The products, methods and compositions of the invention provide improved cleaning effects. While not intending to be limited by theory, it is believed that the dissolved gas in the cleaning composition enhances a cavitation effect created by the ultrasonic energy application during ultrasonic cleaning, thereby enhancing soil and stain removal. These and additional objects and advantages will be more fully apparent in view of the following detailed description.

### BRIEF DESCRIPTION OF THE DRAWINGS

The following detailed description will be more fully understood in view of the drawing in which:

FIG. 1 sets forth a perspective view of an embodiment of an ultrasonic cleaning product according to the invention; and

FIG. 2 sets forth a perspective view of an ultrasonic cleaning device according to the invention including a removable and refillable cleaning composition reservoir.

The embodiments set forth in the drawing are illustrative in nature and are not intended to be limiting of the invention defined by the claims. Moreover, individual features of the drawing and the invention will be more fully apparent and understood in view of the detailed description.

### DETAILED DESCRIPTION

The present invention is directed to ultrasonic cleaning products and to methods for removing soil from a surface to be cleaned. The products and methods provide improved cleaning performance and/or improved cleaning efficiency.

As used herein, the phrase “ultrasonic” cleaning refers to cleaning processes or devices employing ultrasonic waves, i.e. longitudinal waves with frequency above the audible range, wherein the frequency spectra of these waves can vary from about 10 kHz to 10 MHz.

The ultrasonic cleaning products can be utilized for both hard domestic surfaces and fibrous surfaces. A “fibrous surface” includes any fabric surface, such as clothing, including but not limited to, shirts, pants, dresses, skirts, blouses, gloves, hats and shoes, upholstery, such as furniture and car seats, linens, curtains, drapes, carpets, rugs, tapestries, pads, wipes, etc. The “fibrous surface” can be, for example, composed of natural fibers such as cotton, wool or silk; artificial fibers, such as polyesters, rayon or dacron; or blends of natural and artificial fibers, such as polycotton blends. A “hard domestic surface” includes any surface which is traditionally regarded as an inanimate hard surface in a domestic environment, such as, tableware, plates, glasses, cutlery, pots and pans, and also includes other surfaces such as kitchen counter tops, sinks, glass, windows, enamel surfaces, metal surfaces, tiles, bathtubs, walls, ceilings, floors, etc. Indeed, use of products according to the invention significantly improves the removal of domestic stains due to food, grass, greasy materials or body soils, for example, on various surfaces.

As is known in the art, an ultrasonic sonotrode generates ultrasonic waves by application of a voltage across a ceramic material, also referred to as a piezoelectric crystalline material or PZT. The voltage is applied as an alternating current at a desired oscillation frequency and causes movement of the ceramic material. The ceramic material is coupled to a transducer which typically comprises a converter section and a horn section which amplify the motion of the ceramic material. The horn includes a tip, referred to herein as a sonotrode tip, for contact with a soiled surface. The assembly of the ceramic material, converter and horn, including the tip, is commonly referred to herein as the sonotrode. These elements are typically housed with a sonotrode shroud.

While not intending to be limited by theory, it is believed that the ultrasonic energy enhances cleaning via provoking cavitation and generating heat. Cavitation is a well-described phenomenon in the study of liquids. It is the repeated formation and implosion of microscopic bubbles, causing high-pressure shock waves in a liquid and locally generating extremely high temperatures. Heat is also generated by absorption of acoustic energy by the ceramic material, the converter, the horn, a surface to be cleaned, soil and a liquid cleaning composition. This absorption can also be defined as internal friction, and occurs concurrently with heat-generating frictions at the interfaces of the different materials described above. While not intending to be limited by theory, it is believed that ultrasonic energy via cavitation and heat improves rehydration and softening of soil and hence makes it easier to clean. It is believed to do this by increasing the penetration rate of a cleaning solution into soil via the generation of shock waves as described above. These shock waves, locally combined with heat, break the adhesive bonds between the soil and the substrate. The friction heat and the cavitation heat can also both activate specific chemistry (e.g. heat-activated bleach) and hence significantly improve cleaning.

By using the present ultrasonic products and methods, soils and stains can be removed without manually or macroscopically using excessive force, rubbing, pressure or other manipulation which causes wear and tear on the stained material or surface. In doing so, the user does not need to impart such manual energy to remove the soils or stains, thereby adding to the convenience of the user. Throughout the present specification and claims, reference to soil or soiled surfaces refers to and includes soil, soiled surfaces, stains, stained surfaces, and/or surfaces to be cleaned.

The ultrasonic cleaning products according to the present invention comprise a cleaning composition and an ultrasonic wave generating source, i.e., a sonotrode, adapted to impart ultrasonic energy to a surface to be cleaned. The sonotrode oscillates at an ultrasonic frequency. Typically, the sonotrode is adapted to oscillate at a frequency of from about 10 kHz to about 100 kHz. In more specific embodiments, the sonotrode is adapted to oscillate at a frequency of from about 25 kHz to about 50 kHz, and more specifically, from about 30 kHz to about 50 kHz. The amplitude at which the sonotrode oscillates is typically in a range of from about 1 micron to about 100 microns, more specifically in a range of from about 10 microns to about 50 microns, and yet more specifically in a range of from about 20 microns to about 30 microns. Amplitudes of higher values are suitable for obtaining good cleaning of sturdier substrates, for example hard surfaces, carpets, shoes, sofas and the like, while amplitudes at the lower end of these ranges are preferred for more delicate substrates, including garment fabrics such as denim, rayon and the like. Similarly, more difficult or deep soils may be cleaned using higher amplitudes while lighter or surface soils may be cleaned using lower amplitudes.

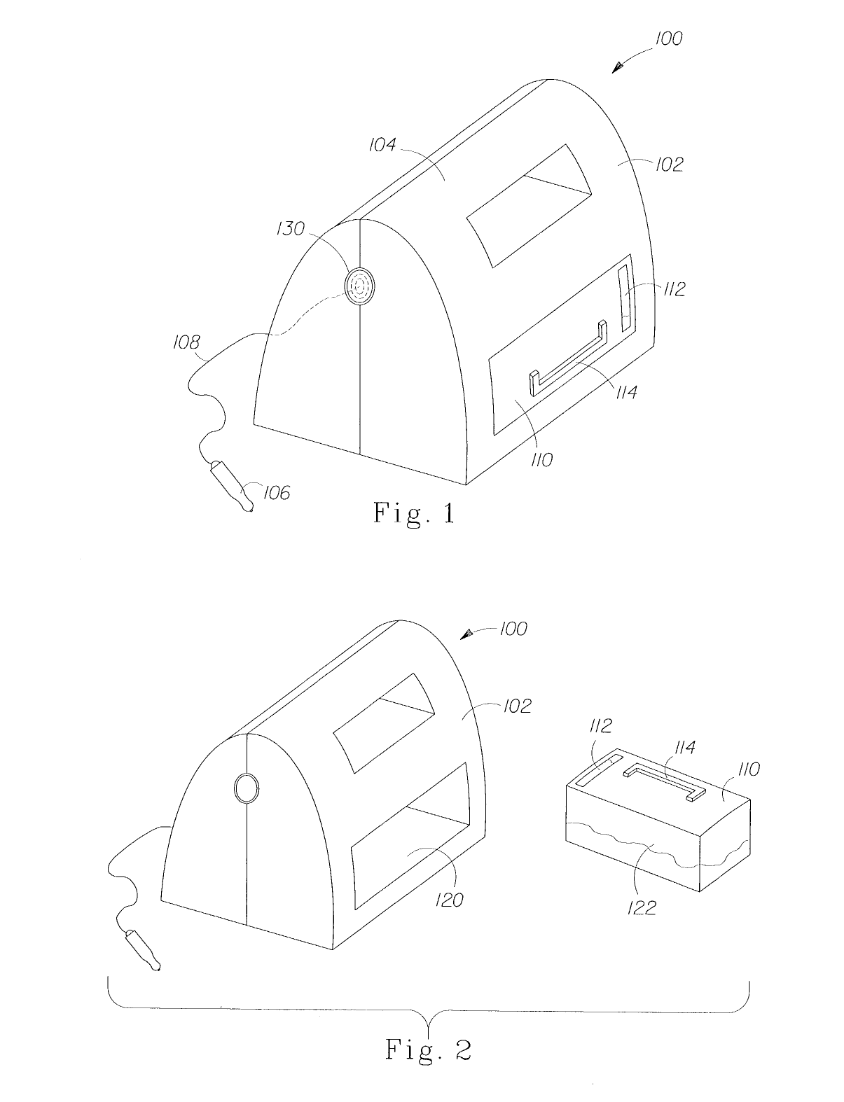

FIG. 1 sets forth a perspective view of an ultrasonic wave generating source which may be employed in the ultrasonic cleaning product according to the present invention. As shown in FIG. 1, the hand held cleaning device 100 includes a housing 102 and a handle 104 on an outer surface of the housing. In a preferred embodiment, the handle 104 is integrally molded with the housing 102 on an upper portion thereof and has a configuration which allows a consumer to easily grasp the handle and transport the ultrasonic cleaning device. The housing may be formed of any suitable material, and in a specific embodiment is formed of molded plastic. The ultrasonic cleaning device includes a sonotrode 106 connected with a power supply (not shown) internally housed within the housing 102. To facilitate provision of a light weight device, the power supply housed within the housing 102 may comprise an electronic step up transformer. A cable 108 of suitable length connects the sonotrode 106 with the power supply. In a preferred embodiment, the cable 108 comprises a dual cable and not only electrically connects the sonotrode with the power supply but also fluid connects the sonotrode with one or more reservoirs of an ultrasonic cleaning composition housed within the housing 102. A panel 110 is provided with a window 112 which conveniently allows a user to monitor the level of cleaning composition within the reservoir. Preferably, the reservoir is refillable or comprises a replaceable cartridge, with access to the reservoir being provided through the panel 110. Conveniently, the panel 110 is provided with a handle 114 to facilitate removal or opening of the panel 110 for access to the reservoir of cleaning composition, shown in FIG. 1.

One embodiment of a refillable reservoir is shown in FIG. 2. The ultrasonic cleaning device 100 including the housing 102 is provided with a cavity or recess 120 for receiving a refillable reservoir 122 of cleaning composition. As shown in FIG. 2, the top surface of the reservoir 122 comprises the panel 110 shown in FIG. 1, provided with the window 112 and the handle 114. The reservoir 122 may be rotated from the upright position shown in FIG. 2 and inserted in the recess 120 so that the panel 110 is flush with the adjacent outer surface of the housing 102. Upon insertion into the recess 120, the reservoir is connected in fluid communication with the cable 108 to supply the cleaning composition to the sonotrode 106.

As shown in FIG. 1, the housing 102 of the ultrasonic cleaning device preferably includes a receptacle 130 adapted for receiving the sonotrode when the ultrasonic cleaning device is not in use. The phantom lines in FIG. 1 show a sonotrode received within the receptacle 130. The receptacle 130 is preferably dimensioned slightly larger than the dimensions of the sonotrode in order to easily receive the sonotrode therein while preventing unintentional displacement of the sonotrode from the receptacle during transport of the ultrasonic cleaning device.

FIGS. 1 and 2 illustrate specific embodiments of an ultrasonic wave generating source for imparting ultrasonic energy to a surface to be cleaned. However, one of ordinary skill in the art will appreciate that the products and methods of the invention may employ other, different embodiments of ultrasonic wave generating sources.

The ultrasonic cleaning products of the invention comprise the ultrasonic wave generating source in combination with a cleaning composition. The cleaning composition comprises a cleaning component and a source of dissolved gas. It has surprisingly been discovered that the inclusion of the source of dissolved gas in the cleaning composition provides improved cleaning performance and/or improved cleaning efficiency, i.e., traditionally difficult-to-remove stains are more easily removed, soil is removed more quickly, and/or more soil is removed for a given energy input. While not intending to be limited by theory, it is believed that the dissolved gas in the cleaning composition enhances the cavitation effect discussed above during ultrasonic cleaning with the cleaning composition, thereby enhancing soil and stain removal.

The cleaning composition suitably comprises the source of dissolved gas in an amount sufficient to improve the ultrasonic cleaning effect of ultrasonic waves applied to a surface to be cleaned and to which the cleaning composition is also applied, particularly as compared with the cleaning effect of the ultrasonic waves applied to a surface to be cleaned in the absence of the cleaning composition. In one embodiment, the cleaning composition comprises from about 0.01% to about 10% by weight, more specifically from about 0.1% to about 5% by weight, of the source of dissolved gas, based on the weight of the cleaning composition.

While not intending to be bound by,theory, the chemical composition of the dissolved gas source for use in the cleaning compositions is not particularly critical, as the dissolved gas is believed to enhance the physical phenomenon of cavitation in the ultrasonic cleaning system as discussed above. The dissolved gas may be chemically inert in the cleaning composition and in the ultrasonic cleaning process employing the cleaning composition. In suitable embodiments, the dissolved gas may comprise, but is not limited to, air, carbon dioxide, nitrogen, oxygen, helium, or mixtures thereof. In a more specific embodiment, the dissolved gas comprises carbon dioxide. One skilled in the art will appreciate that a source of such dissolved gases may be provided in various forms. As examples, carbon dioxide may be provided in a cleaning composition by use of a carbonated water carrier, by including a source of carbon dioxide, for example a bicarbonate compound, therein, or the like. Alternatively, the source of dissolved gas is provided by combining a liquid composition with a gaseous component, for example carbon dioxide, nitrogen, or the like, and packaging the composition under an increased pressure, i.e., a pressure greater than atmosphere. Additional means and forms for providing a dissolved gas in the cleaning composition will be apparent and are within the scope of the invention.

To obtain the improved benefit of the dissolved gas in the cleaning composition, it is important to control the parameters of the cleaning composition in order to maintain the dissolved gas in the composition. Thus, depending on the type of gas and other components of the cleaning composition, the physical form of the composition, and/or the packaging for the composition, it may be necessary to adjust the pH of the composition. Thus, in one embodiment, the cleaning composition has a pH of from about 3 to about 9, more preferably from about 4 to about 7. When a source of carbon dioxide is provided in the cleaning composition by inclusion of sodium carbonate or sodium bicarbonate, the pH of the cleaning composition is preferably maintained at greater than about 4.5, more preferably greater than about 5. In other embodiments, for example, where the cleaning composition is packaged under pressure, and carbon dioxide is provided as the dissolved gas, the pH of the cleaning composition is preferably less than about 5.5, more preferably less than about 5, and even more preferably less than about 4.5. The pH of the cleaning composition is adjusted by use of suitable buffers in a manner well known in the art.

In one embodiment, when the cleaning composition is in liquid form, it is preferred to package the cleaning composition in a manner which facilitates maintaining the dissolved gas in the composition. Thus, the cleaning composition in liquid form is suitably packaged under pressure, for example at a pressure greater than atmospheric, more specifically greater than about 2 bars, even more specifically from about 2 bars to about 5 bars pressure.

The cleaning composition employed in the products and methods of the invention further includes at least one additional cleaning component. The at least one additional cleaning component may comprise any conventional cleaning or detergent component, or mixture thereof, known in the art. For example, the cleaning component may comprise one or more of bleaches, bleach activators, bleach boosters, surfactants, enzymes, enzyme stabilizers, builders, alkalinity sources, colorants, perfumes, antibacterial agents, anti-microbial agents, dispersants, polymeric dye transfer inhibiting agents, crystal growth inhibitors, photobleaches, heavy metal ion sequestrants, anti-tarnishing agents, anti-oxidants, anti-redeposition agents, soil release polymers, electrolytes, pH modifiers, thickeners, abrasives, metal ion salts, corrosion inhibitors, suds stabilizers or suppressors, process aids, fabric softening agents, optical brighteners, hydrotropes, and the like, and mixtures thereof.

The cleaning component may be employed in an amount sufficient to provide the desired functional effect. In one embodiment, the cleaning composition comprises from about 0.0001% to about 40% by weight, more preferably from about 0.1% to about 20% by weight, even more preferably from about 0.5% to about 10% by weight, of the cleaning component, based on the weight of the cleaning composition. Compositions in accordance with this embodiment will typically comprise a majority of an aqueous or nonaqueous carrier or solvent. In an alternate embodiment, the cleaning composition comprises from about 50% to about 99.99% by weight, more preferably from about 80% to about 99.99% by weight, of the cleaning component, based on the weight of the cleaning composition. Compositions in accordance with this embodiment will typically comprise no or only a minor amount of an aqueous and/or nonaqueous carrier or solvent.

The following comprise various nonlimiting examples of components suitable for use as the cleaning component.

Surfactants—The cleaning composition according to the present invention may comprise surfactants selected from anionic surfactants, preferably alkyl alkoxylated sulfates, alkyl sulfates, alkyl disulfates, and/or linear alkyl benzenesulfonate surfactants; cationic surfactants, preferably quaternary ammonium surfactants; nonionic surfactants, preferably alkyl ethoxylates, alkyl polyglucosides, polyhydroxy fatty acid amides, and/or amine or amine oxide surfactants; amphoteric surfactants, preferably betaines and/or polycarboxylates (for example polyglycinates); and zwiterionic surfactants. A wide range of these surfactants can be used in the cleaning compositions of the present invention. A typical listing of classes, and species of these surfactants, is given in U.S. Pat. No 3,664,961 issued to Norris on May 23, 1972. Amphoteric surfactants are also described in detail in “Amphoteric Surfactants, Second Edition”, E. G. Lomax, Editor (published 1996, by Marcel Dekker, Inc.). Suitable surfactants can be found in U.S. patent applications Ser. Nos. 60/032,035 (Docket No. 6401P), 60/031,845 (Docket No. 6402P), 60/031,916 (Docket No. 6403P), 60/031,917 (Docket No. 6404P), 60/031,761 (Docket No. 6405P), 60/031,762 (Docket No. 6406P), 60/031,844 (Docket No. 6409P), No. 60/061,971, Attorney docket No 6881P Oct. 14, 1997, U.S. Serial No. 60/061,975, Attorney docket No 6882P Oct. 14, 1997, U.S. Serial No. 60/062,086, Attorney docket No 6883P Oct. 14, 1997, U.S. Serial No. 60/061,916, Attorney docket No 6884P Oct. 14, 1997, U.S. Serial No. 60/061,970, Attorney docket No 6885P Oct. 14, 1997, U.S. Serial No. 60/062,407, Attorney docket No 6886P Oct. 14, 1997, U.S. Serial No. 60/053,319 filed on Jul. 21, 1997 (Docket No. 6766P), U.S. Serial No. 60/053,318 filed on Jul. 21, 1997 (Docket No. 6767P), U.S. Serial No. 60/053,321 filed on Jul. 21, 1997 (Docket No. 6768P), U.S. Serial No. 60/053,209 filed on Jul. 21, 1997 (Docket No. 6769P), U.S. Serial No. 60/053,328 filed on Jul. 21, 1997 (Docket No. 6770P), U.S. Serial No. 60/053,186 filed on Jul. 21, 1997 (Docket No. 6771P), U.S. Serial No. 60/053,437 filed on Aug. 8, 1997 (Docket No. 6796P), U.S. Serial No. 60/105,017 filed on Oct. 20, 1998 (Docket No. 7303P), and U.S. Serial No. 60/104,962 filed on Oct. 20, 1998 (Docket No. 7304P) all of which are incorporated herein by reference.

The cleaning compositions of the present invention preferably comprise from about 0.01% to about 55%, more specifically from about 0.1% to about 45%, more specifically from about 0.25% to about 30%, and even more specifically from about 0.5% to about 20%, by weight of surfactant. Suitable surfactants include the following.

(1) Anionic surfactants: Nonlimiting examples of anionic surfactants useful herein include the conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)_{X}(CHOSO₃⁻M⁺)CH₃ and CH₃(CH₂)y(CHOSO₃⁻M⁺)CH₂CH₃ where x and y are integers of at least about 7, preferably at least about 9, and M is a water-solubilizing cation, especially sodium, unsaturated sulfates such as oleyl sulfate, the C₁₀-C₁₈ alpha-sulfonated fatty acid esters, the C₁₀-C₁₈ sulfated alkyl polyglycosides, the C₁₀-C₁₈ alkyl alkoxy sulfates (“AE_{X}S”; especially EO 1-7 ethoxy sulfates), and C₁₀-C₁₈ alkyl alkoxy carboxylates (especially the EO 1-5 ethoxycarboxylates). C ₁₀-C₂₀ conventional soaps may also be used. If high sudsing is desired, the branched-chain C₁₀-C₁₆ soaps may be used. Other conventional useful anionic surfactant and cosurfactants are listed in standard texts and are known in the detergent art and are suitable for use herein.

(2) Nonionic surfactants: Nonlimiting examples of nonionic surfactants useful herein include the alkoxylated alcohols (AE's) and alkyl phenols, polyhydroxy fatty acid amides (PFAA's), typical examples of which include the C1₁₂-C₁₈ and C₁₂-C₁₄ N-methylglucamides, see U.S. Pat. Nos. 5,194,639 and 5,298,636, N-alkoxy polyhydroxy fatty acid amides, see U.S. Pat. No. 5,489,393, alkylpolysaccharides such as those disclosed in U.S. Pat. No. 4,565,647, Llenado, issued Jan. 21, 1986, alkyl polyglycosides (APG's), C₁₀-C₁₈ glycerol ethers, polyethylene, polypropylene, and polybutylene oxide condensates of alkyl phenols, and the like. In general, bleach-stable nonionic surfactants are preferred. These nonionic surfactants when present, are included at levels typically of from about 0.1% to about 50%, more specifically from about 0.1% to about 15% of the composition. The nonionic co-surfactant may be a low cloud point nonionic surfactant, a high cloud point nonionic surfactant or mixtures thereof.

(3) Cationic surfactants: Nonlimiting examples of cationic surfactants useful herein typically at levels from about 0.1% to about 50%, by weight include the choline ester-type quats and alkoxylated quaternary ammonium (AQA) surfactant compounds, and the like. Most preferred for aqueous liquid compositions herein are soluble cationic surfactants which do not readily hydrolyze in the product. Cationic choline ester-type quat surfactants which are preferably water dispersible comprise at least one ester (i.e. —COO—) linkage and at least one cationically charged group, and are disclosed in U.S. Pat. Nos. 4,228,042, 4,239,660 and 4,260,529. Suitable alkoxylated quaternary ammonium (AQA) surfactant compounds are disclosed in EP 2,084, published May 30, 1979, by The Procter & Gamble Company. The levels of the cationic surfactants used to prepare cleaning compositions typically range from about 0.1% to about 5%, preferably from about 0.45% to about 2.5%, by weight.

(4) Other Surfactants: Amphoteric or zwitterionic detersive surfactants, when present, are usually useful at levels in the range from about 0. 1% to about 20% by weight of the cleaning composition. Often levels will be limited to about 5% or less, especially when the amphoteric is costly. Suitable amphoteric surfactants include, but are not limited to, the amine oxides of the formula RR′R″N→O wherein R is a primary alkyl group containing 6-24 carbons, preferably 10-18 carbons, and wherein R′ and R″ are, each, independently, an alkyl group containing 1 to 6 carbon atoms. The arrow in the formula is a conventional representation of a semi-polar bond. The amine oxide is typically used in an amount of from about 0.1% to about 20%, more specifically about 0.1% to about 15%, even more specifically still from about 0.5% to about 10%, by weight of the cleaning composition.

Suitable zwitterionic surfactants include the betaine and betaine-like surfactants wherein the molecule contains both basic and acidic groups which form an inner salt giving the molecule both cationic and anionic hydrophilic groups over a broad range of pH values. Some common examples of these s are described in U.S. Pat. Nos. 2,082,275, 2,702,279 and 2,255,082. Zwitterionics, which typically contain both a quaternary ammonium group and an anionic group selected from sulfonate and carboxylate groups, are desirable since they maintain their amphoteric character over a wide pH range.

Enzymes—While in one aspect of the present invention, the compositions are substantially free from enzymes, in another aspect of the present invention it is within the scope of the present invention to incorporate enzymes. Suitable enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. In one embodiment, a cocktail of conventional applicable enzymes like protease, amylase, lipase, cutinase and/or cellulase is employed. The enzymes may be incorporated into detergent compositions herein in the form of suspensions, “marumes” or “prills”. Another suitable type of enzyme comprises those in the form of slurries of enzymes in nonionic surfactants, e.g., the enzymes marketed by Novo Nordisk under the tradename “SL” or the microencapsulated enzymes marketed by Novo Nordisk under the tradename “LDP.” If employed, enzymes will normally be incorporated into the non-aqueous liquid compositions herein at levels sufficient to provide up to about 10 mg by weight, more typically from about 0.01 mg to about 5 mg, of active enzyme per gram of the composition. Stated otherwise, the non-aqueous liquid detergent compositions herein will typically comprise from about 0.001% to 5%, preferably from about 0.01% to 1% by weight, of a commercial enzyme preparation.

Enzyme Stabilizing System—The enzyme-containing compositions herein may optionally also comprise from about 0.001% to about 10%, preferably from about 0.005% to about 8%, most preferably from about 0.01% to about 6%, by weight of an enzyme stabilizing system. The enzyme stabilizing system can be any stabilizing system which is compatible with the detersive enzyme. Such a system may be inherently provided by other formulation actives, or be added separately, e.g., by the formulator or by a manufacturer of detergent-ready enzymes. Such stabilizing systems can, for example, comprise calcium ion, boric acid, propylene glycol, short chain carboxylic acids, boronic acids, and mixtures thereof, and are designed to address different stabilization problems depending on the type and physical form of the cleaning composition.

Perfumes—Perfumes and perfumery ingredients useful in the present compositions and processes comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes typically comprise from about 0.01% to about 2%, by weight, of the cleaning compositions, and individual perfumery ingredients can comprise from about 0.0001% to about 90% of a finished perfume composition.

Dispersant Polymer—The cleaning compositions of the present invention may additionally contain a dispersant polymer. When present, a dispersant polymer is typically at levels in the range from 0 to about 25%, specifically from about 0.5% to about 20%, more specifically from about 1% to about 8% by weight of the composition. Particularly preferred are polymers which inhibit the deposition of calcium carbonate or magnesium silicate on dishware. Dispersant polymers suitable for use herein are further illustrated by the film-forming polymers described in U.S. Pat. No. 4,379,080 (Murphy), issued Apr. 5, 1983. Suitable polymers are preferably at least partially neutralized or alkali metal, ammonium or substituted ammonium (e.g., mono-, di- or triethanolammonium) salts of polycarboxylic acids. Other suitable dispersant polymers include those disclosed in U.S. Pat. Nos. 3,308,067, 4,530,766, 3,723,322, 3,929,107, 3,803,285, 3,629,121, 4,141,841, and 5,084,535; EP Pat. No. 66,915. Copolymers of acrylamide and acrylate having a molecular weight of from about 3,000 to about 100,000, preferably from about 1,000 to about 20,000, and an acrylamide content of less than about 50%, preferably less than about 20%, by weight of the dispersant polymer can also be used. Other dispersant polymers useful herein include the polyethylene glycols and polypropylene glycols having a molecular weight of from about 950 to about 30,000, the cellulose sulfate esters, and polyaspartate.

Bleaching Agents and Bleach Activators—The cleaning compositions herein preferably contain a bleach and/or a bleach activator. Bleaching agents will typically, when present, be at levels of from about 1% to about 30%, more typically from about 5% to about 20%, of the cleaning composition, especially for fabric cleaning. If present, the amount of bleach activators will typically be from about 0.1 % to about 60%, more typically from about 0.5% to about 40% of the cleaning composition.

The bleaches used herein can be any of the bleaches useful for detergent compositions in textile cleaning, hard surface cleaning, or other cleaning purposes that are now known or become known. These include oxygen bleaches as well as other bleaching agents. Peroxygen bleaches, including percarbonate bleaches and perborate bleaches, e.g., sodium perborate (e.g., mono- or tetra-hydrate), and hydrogen peroxide, can be used herein. Also suitable are organic or inorganic peracids. Suitable organic or inorganic peracids for use herein include: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium perphthalic acid; perlauric acid; phthaloyl amidoperoxy caproic acid (PAP); perbenzoic and alkylperbenzoic acids; and mixtures thereof. Alternatively, although not preferred, the bleach can be a chlorine bleach. Chlorine bleaches can be any convenient conventional chlorine bleach. Such compounds are often divided in to two categories namely, inorganic chlorine bleaches and organic chlorine bleaches.

Suitable organic percarboxylic acid and peroxycarboxylic acid bleaching agents are disclosed in U.S. Pat. No. 4,483,781, Hartman, issued Nov. 20, 1984, U.S. Pat. No. 4,634,551 to Burns et al., European Patent Application 0,133,354, Banks et al. published Feb. 20, 1985, U.S. Pat. No. 4,412,934, Chung et al. issued Nov. 1, 1983 and U.S. Pat. No. 4,634,551, issued Jan. 6, 1987 to Burns et al. Suitable peracid compounds are described in U.S. Pat. Nos. 5,487,818, 5,310,934, 5,246,620, 5,279,757 and 5,132,431.

Hydrogen peroxide is particularly suitable for use as a bleach in the cleaning compositions of the present invention. Typically, a source of hydrogen peroxide may be used in an amount of from about 0.05% to about 15%, more specifically from about 0.1% to about 4%, more specifically from about 0.3% to about 3%, and more specifically from about 0.5% to about 3%, by weight of the cleaning composition.

Bleach Activators—Bleach activators useful herein include amides, imides, esters and anhydrides. Commonly at least one substituted or unsubstituted acyl moiety is present, covalently connected to a leaving group as in the structure R—C(O)-L. In one preferred mode of use, bleach activators are combined with a source of hydrogen peroxide, such as the perborates or percarbonates, in a single product. Conveniently, the single product leads to in situ production in aqueous solution (i.e., during the washing process) of the percarboxylic acid corresponding to the bleach activator. The product itself can be hydrous, for example a powder, provided that water is controlled in amount and mobility such that storage stability is acceptable. Alternately, the product can be an anhydrous solid or liquid. With respect to the above bleach activator structure RC(O)L, the atom in the leaving group connecting to the peracid-forming acyl moiety R(C)O— is most typically O or N. Bleach activators can have non-charged, positively or negatively charged peracid-forming moieties and/or noncharged, positively or negatively charged leaving groups. One or more peracid-forming moieties or leaving-groups can be present. See, for example, U.S. Pat. No. 5,595,967, U.S. Pat. No. 5,561,235, U.S. 5,560,862 or the bis-(peroxy-carbonic) system of U.S. Pat. No. 5,534,179. Mixtures of suitable bleach activators can also be used. Bleach activators can be substituted with electron-donating or electron-releasing moieties either in the leaving-group or in the peracid-forming moiety or moieties, changing their reactivity and making them more or less suited to particular pH or wash conditions. An extensive and exhaustive disclosure of suitable bleach activators and suitable leaving groups, as well as how to determine suitable activators, can be found in U.S. Pat. Nos. 5,686,014, 5,622,646, U.S. Pat. No. 5,503,639, U.S. Pat. No. 4,966,723, U.S. Pat. No. 4,915,854, U.S. Pat. No. 4,751,015, U.S. Pat. Nos. 4,545,784 and 4,397,757, EP-A-284292, EP-A-331,229, EP-A-303,520 EP-A-458,396 and EP-A-464,880.

Bleaching Stabilizers—The compositions herein may further contain a bleach stabilization system. Bleach stabilizing agents will typically, when present, be at levels of from about 0.0005% to about 20%, more typically from about 0.001% to about 10%, even more preferably from about 0.01 to about 5% of the detergent composition, wherein said stabilizer is selected from the group consisting of chelants, builders, and buffers. Suitable bleach stabilizing agents include ethylenediamine-tetraacetic acid (EDTA), borate buffer, phosphorus containing buffers, cyclohexane-1,2-diaminotetrakismethylene phosphonic acid buffer and mixtures thereof. Additional bleach stabilizing agents are well known in the patent art and are exemplified in WO 93/13012, U.S. Pat. No. 4,363,699, U.S. Pat. No. 5,759,440, and U.S. Pat. No. 4,783,278.

In a specific embodiment, the cleaning compositions of the invention comprise a source of hydrogen peroxide as a bleach component. In a further embodiment, the hydrogen peroxide bleach includes a stabilizer, which may be supplied integral with the hydrogen peroxide bleach component or as a separate bleach stabilizer component. A preferred bleach stabilizer is ethylenediaminetetraacetic acid (EDTA), and is used in an amount of less than about 0.1%, more specifically less than about 0.05%, by weight of the cleaning composition.

Builders—Builders can operate via a variety of mechanisms including forming soluble or insoluble complexes with hardness ions, by ion exchange, and by offering a surface more favorable to the precipitation of hardness ions than are the surfaces of articles to be cleaned. Builder level can vary widely depending upon end use and on other components and the physical form of the composition. For example, high-surfactant formulations can be unbuilt. The cleaning compositions may optionally comprise at least about 0.1%, preferably from about 1% to about 90%, more preferably from about 5% to about 80%, even more preferably from about 10% to about 40% by weight, of detergent builder. Lower or higher levels of builder, however, are not excluded.

Suitable builders include, but are not limited to, phosphates and polyphosphates, especially the sodium salts; carbonates, bicarbonates, sesquicarbonates and carbonate minerals other than sodium carbonate or sesquicarbonate; organic mono-, di-, tri-, and tetracarboxylates, including citrates, especially water-soluble nonsurfactant carboxylates in acid, sodium, potassium or alkanolammonium salt form, as well as oligomeric or water-soluble low molecular weight polymer carboxylates including aliphatic and aromatic types; phytic acid; aluminosilicates and silicates, including zeolites such as Zeolite A, Zeolite P (B), Zeolite X and Zeolite MAP; and natural and synthetic mineral builders. These may be complemented by borates, e.g., for pH-buffering purposes, or by sulfates, especially sodium sulfate and any other fillers or carriers which may be important to the engineering of stable surfactant and/or builder-containing detergent compositions.

Builder mixtures, sometimes termed “builder systems” can be used and typically comprise two or more conventional builders, optionally complemented by chelants, pH-buffers or fillers, though these latter materials are generally accounted for separately when describing quantities of materials herein. In terms of relative quantities of surfactant and builder in the present granular compositions, preferred builder systems are typically formulated at a weight ratio of surfactant to builder of from about 60:1 to about 1:80.

Polymeric Soil Release Agent—The compositions according to the present invention may optionally comprise one or more soil release agents. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of the laundry cycle and serve as an anchor for the hydrophilic segments. This can enable stains occurring subsequent to treatment with the soil release agent to be more easily cleaned in later washing procedures. If utilized, soil release agents will generally comprise from about 0.01% to about 10% preferably from about 0.1% to about 5%, more preferably from about 0.2% to about 3% by weight, of the composition. The following, all included herein by reference, describe soil release polymers suitable for use herein: U.S. Pat. No. 5,691,298 Gosselink et al., issued Nov. 25, 1997; U.S. Pat. No. 5,599,782 Pan et al., issued Feb. 4, 1997; U.S. Pat. No. 5,415,807 Gosselink et al., issued May 16, 1995; U.S. Pat. No. 5,182,043 Morrall et al., issued Jan. 26, 1993; U.S. Pat. No. 4,956,447 Gosselink et al., issued Sep. 11, 1990; U.S. Pat. No. 4,976,879 Maldonado et al. issued Dec. 11, 1990; U.S. Pat. No. 4,968,451 Scheibel et al., issued Nov. 6, 1990; U.S. Pat. No. 4,925,577 Borcher, Sr. et al., issued May 15, 1990; U.S. Pat. No. 4,861,512 Gosselink, issued Aug. 29, 1989; U.S. Pat. No. 4,877,896 Maldonado et al., issued Oct. 31, 1989; U.S. Pat. No. 4,702,857 Gosselink et al., issued Oct. 27, 1987; U.S. Pat. No. 4,711,730 Gosselink et al., issued Dec. 8, 1987; U.S. Pat. No. 4,721,580 Gosselink issued Jan. 26, 1988; U.S. Pat. No. 4,000,093 Nicol et al., issued Dec. 28, 1976; U.S. Pat. No. 3,959,230 Hayes, issued May 25, 1976; U.S. Pat. No. 3,893,929 Basadur, issued Jul. 8, 1975; and European Patent Application 0 219 048, published Apr. 22, 1987 by Kud et al.

Clay Soil Removal/Anti-redeposition Agents—The compositions of the present invention can also optionally contain clay soil removal and antiredeposition agents, for example, water-soluble ethoxylated amines, typically in amounts of from about 0.01% to about 10.0% by weight, more specifically about 0.01% to about 5%.

Brightener—Any optical brighteners or other brightening or whitening agents known in the art can be incorporated at levels typically from about 0.01% to about 1.2%, by weight, into the cleaning compositions. Suitable optical brighteners include, but are not limited to, derivatives of stilbene, pyrazoline, coumarin, carboxylic acid, methinecyanines, dibenzothiophene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Dye Transfer Inhibiting Agents—The cleaning compositions of the present invention may also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%.

Suds Stabilizers and Suppressors—Compounds for stabilizing foam or suds or compounds for reducing or suppressing the formation of suds can be incorporated into the cleaning compositions of the present invention. Both of such compounds are known

In a preferred embodiment, the compositions comprise a suds suppressor. A wide variety of suds suppressors are well known to those skilled in the art and may be used. See, for example, Kirk Othmer Encyclopedia of Chemical Technology, Third Edition, Volume 7, pages 430-447 (John Wiley & Sons, Inc., 1979). Suitable suds suppressors include monocarboxylic fatty acid and soluble salts thereof, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), etc., N-alkylated amino triazines, propylene oxide, and monostearyl phosphates such as monostearyl alcohol phosphate ester and monostearyl di-alkali metal (e.g., K, Na, and Li) phosphates and phosphate esters, and secondary alcohols (e.g., 2-alkyl alkanols) and mixtures of such alcohols with silicone oils. Another preferred category of non-surfactant suds suppressors comprises silicone suds suppressors, including polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressors are well known in the art and are, for example, disclosed in U.S. Pat. No. 4,265,779, issued May 5, 1981 to Gandolfo et al. See also U.S. Pat. Nos. 4,978,471, Starch, issued Dec. 18, 1990, and 4,983,316, Starch, issued Jan. 8, 1991, 5,288,431, Huber et al., issued Feb. 22, 1994, and U.S. Pat. Nos. 4,639,489 and 4,749,740, Aizawa et al at column 1, line 46 through column 4, line 35.

The compositions herein may comprise from 0% to about 10%, more specifically from 0% to about 5%, and more specifically, from about 0.5% to about 3%, by weight, of suds suppressor.

Antibacterial Agents and Antimicrobial Agents—An antibacterial agent is a compound or substance that kills bacteria or prevents or inhibits their growth, while an antimicrobial agent is a compound or substance that kills microorganisms or prevents or inhibits their growth and reproduction. A properly selected agent maintains stability under use and storage conditions (pH, temperature, light, etc.), for a required length of time. Desirable properties of such agents are that they are safe and nontoxic in handling, formulation and use, environmentally acceptable and cost effective. Classes of antibacterial and antimicrobial agents include, but are not limited to, chlorophenols, aldehydes, biguanides, antibiotics and biologically active salts. Some preferable antimicrobial agents are bronopol, chlorhexidine diacetate, TRICLOSAN®, hexetidine and parachlorometaxylenol (PCMX).

An antibacterial and/or antimicrobial agent, when used, is present in a microbiocidally effective amount, more preferably in an amount of from about 0.01% to about 10.0%, more preferably from about 0.1% to about 8.0%, even more preferably from about 0.5% to about 2.0%, by weight of the composition.

As set forth above, the cleaning compositions may also comprise one or more cleaning components including, but not limited to, alkalinity sources, colorants, crystal growth inhibitors, photobleaches, heavy metal ion sequestrants, anti-tarnishing agents, antioxidants, electrolytes, pH modifiers, thickeners, abrasives, metal ion salts, corrosion inhibitors, process aids, fabric softening agents, hydrotropes, and the like, and mixtures thereof. These components are well known for use in various detergent compositions and may be used in a like manner in the present cleaning compositions.

The cleaning composition may comprise any physical form including granular, powder, tablet, gel, liquid or the like. In embodiments wherein the cleaning composition is in a powder, granular or tablet form, it is envisioned that the composition will be converted to a gel or liquid form for use in combination with an ultrasonic wave generating source. Thus, the liquid compositions may comprise, and the non-liquid compositions may be adapted for dissolution or dispersion with, one or more liquid carriers. The liquid carrier may act as a solvent for the cleaning composition components, and/or as a carrier in which the cleaning composition components are dispersed rather than dissolved. As used hereinafter, the term “carrier” is used to include liquid mediums in which the cleaning compositions are dissolved and/or dispersed.

Suitable carriers include water, alone or in combination with organic carriers. In one embodiment, the cleaning composition may comprise from about 10% to about 99% by weight, more specifically from about 50 to about 98% by weight, and more specifically from about 80% to about 98% by weight, of water. In an alternate embodiment, the carrier may contain little or no water, i.e., less than about 5%, and more preferably less than about 1%, water, whereby the cleaning composition is essentially nonaqueous.

Carriers suitable for use in the cleaning compositions of the invention further include organic carriers such as lower alcohols, i.e., methanol, ethanol, propanol, isopropanol, butanol, or mixtures thereof, and glycol ethers. Glycol ethers are well known in the art and include, but are not limited to, methoxy propoxy propanol, ethoxy propoxy propanol, propoxy propoxy propanol, butoxy propoxy propanol, butoxy propanol, and mixtures thereof. These organic carriers may be used in any amount suitable for providing a desired liquid form and effect. Typically, organic carriers are employed in an amount of from about 0 to about 50% by weight, more specifically from about 0.1% to about 25% by weight, and more specifically from about 0.5% to about 10% by weight, of the cleaning composition. In one embodiment, a glycol ether, or mixture thereof, is used in a low but effective amount, for example at a level of from about 0.1 % to about 5%, by weight of the cleaning composition.

The methods for removing soil from a surface in need of cleaning according to the invention comprise applying a cleaning composition as described herein comprising a cleaning component and a source of dissolved gas to a surface in need of cleaning, and contacting the surface with a source of ultrasonic energy. Specifically, the ultrasonic energy is directed to the surface area in need of cleaning and to which the cleaning composition is applied. The cleaning composition may be applied by spraying, or via an outlet adjacent to the tip of the sonotrode. For example, when using a source of ultrasonic energy as set forth in FIGS. 1 and 2, wherein a reservoir of cleaning compositions is in fluid communication with a sonotrode, the sonotrode may be designed to simultaneously apply the cleaning composition and ultrasonic energy to a surface area in need of cleaning.

| Component | A | B | C | D |
|---|---|---|---|---|
| Surfactant Base | 2 | 2 | 2 | 2 |
| Butoxy propoxy propanol | 2 | 2 | 2 | 2 |
| EDTA | 0.005 | 0.005 | 0.005 | 0.005 |
| Stabilized H₂O₂ (35%) | 2.5 | — | 2.5 | — |
| Perfume (2% in ethanol) | 0.51 | 0.51 | 0.51 | 0.51 |
| Water | 92.985 | 95.485 | 92.985 | 95.485 |

### EXAMPLES

The following examples demonstrate ultrasonic cleaning products according to the invention. Throughout the examples and the remainder of the specification, parts and percentages are by weight unless otherwise specified.

Cleaning compositions A-D as described in Table 1 are prepared.

### Table 1-Cleaning Compositions

The surfactant base composition is set forth in Table 2.

TABLE 2
Surfactant Base

| Component | Weight percent |
|---|---|
| Sodium lauryl sulfate paste (70%) | 28.6 |
| Ethanol | 6.275 |
| Alkyldimethylamine oxide | 3.514 |

| | |
|---|---|
| Sodium xylene sulfonate | 3.012 |
| Magnesium sulfate-crystalline | 0.382 |
| Epsom salts (MgSO₄—7H₂O) | |
| Magnesium chloride solution | 0.452 |
| Citric acid anhydrous | 0.050 |
| Water | 57.715 |

A trace of 50% NaOH is added to each composition to provide a pH of about 9. For each composition, all ingredients are mixed together, and 200 ml of the resulting solution is placed in a metal container. Compositions A and B are placed under a N₂ pressure of 4.5 bars (Equipment Comes Gaser-Shaker Type GS-91/95-E). Compositions C and D are placed under a CO₂ pressure of 2.72 bars (Equipment Comes Gaser-Shaker Type GS-91/95-E). Each composition is used in an ultrasonic cleaning method wherein a portion of the composition is applied to a surface to be cleaned, and ultrasonic energy is applied to the surface. Increased cleaning speed is observed, particularly on tough food stains like spaghetti sauce.

The specific illustrations, examples and embodiments described herein are exemplary only in nature and are not intended to be limiting of the invention defined by the claims. Further embodiments and examples will be apparent to one of ordinary skill in the art in view of the specification and are within the scope of the claimed invention.

What is claimed is:

1. An ultrasonic cleaning product comprising:
(a) a cleaning composition comprising a cleaning component and a source of dissolved gas; and
(b) an ultrasonic wave generating source for imparting ultrasonic energy to a surface to be cleaned.

2. The ultrasonic cleaning product of claim 1, wherein the cleaning composition comprises from about 0.0001% to about 40% by weight of the cleaning component, based on the weight of the cleaning composition.

3. The ultrasonic cleaning product of claim 1, wherein the cleaning composition comprises from about 50% to about 99.99% by weight of the cleaning component, based on the weight of the cleaning composition.

4. The ultrasonic cleaning product of claim 1, wherein the cleaning composition comprises from about 0.01% to about 10% by weight of the source of dissolved gas, based on the weight of the cleaning composition.

5. The ultrasonic cleaning product of claim 4, wherein the dissolved gas comprises air, carbon dioxide, nitrogen, oxygen, helium, or mixtures thereof.

6. The ultrasonic cleaning product of claim 1, wherein the source of dissolved gas comprises a bicarbonate compound.

7. The ultrasonic cleaning product of claim 1, wherein the cleaning composition has a pH of from about 3 to about 9.

8. The ultrasonic cleaning product of claim 1, wherein the cleaning component is selected from the group consisting of bleaches, bleach activators, bleach boosters, surfactants, enzymes, enzyme stabilizers, builders, alkalinity sources, colorants, perfumes, antibacterial agents, antimicrobial agents, dispersants, polymeric dye transfer inhibiting agents, crystal growth inhibitors, photobleaches, heavy metal ion sequestrants, anti-tarnishing agents, anti-oxidants, anti-redeposition agents, soil release polymers, electrolytes, pH modifiers, thickeners, abrasives, metal ion salts, corrosion inhibitors, suds stabilizers, suds suppressors, process aids, fabric softening agents, optical brighteners, hydrotropes, and mixtures thereof.

9. The ultrasonic cleaning product of claim 1, wherein the cleaning component comprises a bleach.

10. The ultrasonic cleaning product of claim 9, wherein the cleaning composition further comprises from about 0.05% to about 15% by weight of a source of hydrogen peroxide.

11. The ultrasonic cleaning product of claim 1 wherein the ultrasonic energy has a frequency of from about 10 kHz to about 100 kHz.

12. The ultrasonic cleaning product of claim 1 wherein the ultrasonic energy has an amplitude of from about 1 micron to about 100 microns.

13. The ultrasonic cleaning product of claim 1 wherein the cleaning composition and the ultrasonic source are contained together in a device that is adapted for controlled dispensing of the cleaning composition to a surface in need of cleaning, while concurrently imparting ultrasonic energy thereto.

14. A method for removing soil from a surface in need of cleaning, comprising (a) applying a cleaning composition comprising a cleaning component and a source of a dissolved gas to a surface in need of cleaning, and (b) contacting the surface with a source of ultrasonic energy.

15. The method of claim 14 wherein the source of ultrasonic energy has a frequency of from about 10 kHz to about 100 kHz.

16. The method of claim 14 wherein the ultrasonic energy has an amplitude of from about 1 micron to about 100 microns.

17. The method of claim 14 wherein the cleaning composition comprises from about 0.01% to about 10% by weight of the source of dissolved gas, based on the weight of the cleaning composition.

18. The method of claim 14 wherein the dissolved gas comprises air, carbon dioxide, nitrogen, oxygen, helium, or mixtures thereof.

19. The method of claim 14 wherein the cleaning composition has a pH of from about 3 to about 9.

20. An ultrasonic cleaning composition comprising a cleaning component and a source of dissolved gas.
